(19) United States
(12) Patent Application Publication
(10) Pub. No.: US 2026/0318275 A1
(43) Pub. Date: Oct. 15, 2026

(54) EIGHT-ARC CYLINDRICAL VORTEX-INDUCED VIBRATION SUPPRESSION AND POWER GENERATION DEVICE FOR MARINE RISER

(71) Applicant: JIANGSU UNIVERSITY OF SCIENCE AND TECHNOLOGY, Jiangsu (CN)

(72) Inventors: Sheng Xu, Jiangsu (CN); Zhoujie Guo, Jiangsu (CN)

(73) Assignee: JIANGSU UNIVERSITY OF SCIENCE AND TECHNOLOGY, Jiangsu (CN)

(21) Appl. No.: 19/423,927

(22) Filed: Dec. 17, 2025

(30) Foreign Application Priority Data
Apr. 11, 2025 (CN) 202510450684.3

(51) Int. Cl. F03B 13/18; H02N 2/18

(52) U.S. Cl. CPC F03B 13/183; H02N 2/186; F05B 2220/709; F05B 2240/12; F05B 2260/4031; F05B 2260/96

(57) ABSTRACT

An eight-arc cylindrical vortex-induced vibration suppression and power generation device for a marine riser includes a marine riser, a protection module, a power transmission module, and a power generation module; the protection module includes inner and outer mounting tubes; the outer mounting tube includes a middle section having an arc-shaped notch; both ends of the middle section are provided with working chambers, and a plurality of thrust rods are arranged circumferentially around each working chamber; one end of each thrust rod is provided with an outer arc-shaped shell; the power transmission module includes a rotating impeller, a fixed rod, a driving spur-helical gear, and an eccentric disc; the power generation module includes arc-shaped piezoelectric plates; the outer arc-shaped shell includes an upper base plate embedded with an upper electrode, and a lower base plate embedded with a lower electrode; and an electret is mounted on the lower electrode.

### CROSS-REFERENCE TO RELATED APPLICATION

This application claims the priority benefit of China application serial no. 202510450684.3, filed on Apr. 11, 2025. The entirety of the above-mentioned patent application is hereby incorporated by reference herein and made a part of this specification.

### BACKGROUND

### Technical Field

The present disclosure relates to the technical field of marine engineering, and in particular to an eight-arc cylindrical vortex-induced vibration suppression and power generation device for a marine riser.

### Description of Related Art

Marine risers are conduits connecting surface floating installations to subsea equipment (such as wellheads and manifolds), and they are the critical structures for the development of offshore oil and gas resources. Marine risers have various possible structural forms, including top-tensioned risers, steel catenary risers, flexible risers, and free-standing risers. Since marine risers operate in harsh marine environments for long periods, they are highly susceptible to ocean currents. When an ocean current velocity reaches a certain level, and the vortex shedding frequency coincides with the natural frequency of the riser, the riser may suffer from vortex-induced vibration, which is a key factor causing the riser’s fatigue failure. This not only poses serious threats to operational safety, but also increases offshore production time and cost of offshore oil and gas extraction. In addition, with ongoing economic prosperity at present, the demand for energy is increasing rapidly. Exploring cleaner and renewable energy sources is of great significance for meeting long-term future energy needs and reducing dependence on fossil fuels. Offshore new energy has gradually emerged as a promising major contributor to new energy in the short- to medium-term. The ocean contains abundant clean energy resources such as wave energy, tidal energy, and ocean current energy, and large-scale exploitation and utilization of these clean energy resources is expected to become a key support for the current energy structure transformation. In summary, ensuring safe and stable operation of marine risers, and developing and utilizing new energy sources in harsh marine environments have become core challenges in the field of marine energy development. Moreover, existing marine riser vortex-induced vibration suppression devices suffer from limited functionality and low utilization efficiency of marine energy. Therefore, it is necessary to develop a novel vortex-induced vibration suppression and power generation device for a marine riser to address the above problems.

Current marine riser vortex-induced vibration suppression devices face several deficiencies, including limited technical performance, for example, helical strakes show reduced vibration suppression performance under high current velocities or complex flow directions; fairings are direction-sensitive and occupy large installation space; and passive devices cannot dynamically adapt to changing sea conditions. Reliability is also an issue, specifically, material aging caused by high pressure and deep-sea corrosive environment, biofouling weakens device performance. Active control systems rely on high-precision algorithms and stable power supply. Economic challenges include high installation and maintenance costs, and customized designs hinder large-scale deployment. In addition, design bottlenecks exist, for example, existing devices often lack insufficient synergy among individual technologies and multi-physics coupling optimization. These deficiencies limit the ability to provide long-term stable performance in extreme deep-water conditions and dynamic ocean environments.

### SUMMARY

In view of the deficiencies in the prior art, the present disclosure provides an eight-arc cylindrical vortex-induced vibration suppression and power generation device for a marine riser, where each flow-impinging surface of the eight-arc cylinder is m-shaped, and the arc-shaped structure can change a flow direction of ocean currents, thereby reducing the impact force of ocean currents, thus lowering the intensity of vortex-induced vibration. This alleviates the hydrodynamic load on the marine riser and provides protective effects for the marine riser. The eight-arc cylindrical structure and the reciprocating motion of the outer arc-shaped shell driven by the rotating impeller along a normal direction both serve to suppress vibration of the marine riser. In addition, the present disclosure utilizes piezoelectric power generation and electret-based power generation principle to generate electrical energy, thereby efficiently utilizing marine energy. This enables the conversion of ocean current energy into electrical energy in an environmentally friendly manner, while simultaneously suppressing vortex-induced vibrations of the marine riser.

Technical solution: the present disclosure provides an eight-arc cylindrical vortex-induced vibration suppression and power generation device for a marine riser, including a marine riser, a protection module, a power transmission module, and a power generation module;

the protection module includes an inner mounting tube disposed on an outer side of the marine riser; an outer mounting tube is disposed on an outer side of the inner mounting tube; the outer mounting tube includes a middle section having an arc-shaped notch; both ends of the middle section are provided with working chambers, and a plurality of thrust rods are arranged circumferentially around each working chamber; one end of each thrust rod is provided with an outer arc-shaped shell; and a first hole, a second hole, and a third hole are formed in a bottom of the working chamber;

the power transmission module includes a rotating impeller, a fixed rod, a driving spur-helical gear, and an eccentric disc; the fixed rod is coaxial with the first hole, the rotating impeller, and the driving spur-helical gear; the rotating impeller is located in a position of the arc-shaped notch; the driving spur-helical gear is engaged with two bidirectional spur-helical gears, and one end of each of the bidirectional spur-helical gears is engaged with a driven spur-helical gear; each driven spur-helical gear passes through a power hole and is connected to a lower rod of the eccentric disc; an upper rod of the eccentric disc is connected to a straight-slot connecting rod, and the straight-slot connecting rod is connected to the thrust rod; and

the power generation module includes arc-shaped piezoelectric plates distributed on the outer arc-shaped shell; the outer arc-shaped shell includes an upper base plate embedded with an upper electrode, and a lower base plate embedded with a lower electrode; a spring is connected between the upper base plate and the lower base plates; and each arc-shaped piezoelectric plate is provided with a supporting rod connected to the upper base plate, and an electret is mounted on the lower electrode.

The middle section is a cylindrical body having arc-shaped notches in a plurality of directions. These arc-shaped notches not only reduce a structural weight but also optimize a flow path of ocean currents, thereby reducing the impact force of ocean currents on the device.

The middle section and both ends of the outer arc-shaped shell are provided with limiting blocks to limit movement trajectories of the arc-shaped piezoelectric plates, ensuring that the piezoelectric plates remain within a predetermined track during operation.

The outer arc-shaped shell is provided with mounting holes for connecting the supporting rod with the upper base plate.

The thrust rods are sleeved with thrust-rod protective casings.

The upper rod of the eccentric disc is fixedly connected to a straight slot of the straight-slot connecting rod.

The outer arc-shaped shells are distributed around its circumference to form an eight-arc cylindrical structure.

Both ends of the inner mounting tube are secured by tube body reinforcing members connected by mounting bolt assemblies on an outer side. The tube body reinforcing members not only enhance a structural strength of the inner mounting tube but also provide overall stability to the entire device.

The power holes formed in the working chamber are a second hole and a third hole, through which the two driven spur-helical gears pass.

The rotating impeller has obliquely curved blades. The rotation of the rotating impellers reduces the flow velocity of ocean currents on the device.

Working principle: The present disclosure adopts a multi-stage energy dissipation and dual-mode energy conversion system, forming a synergistic vibration-suppression mechanism that integrates external flow guidance, internal dissipation, and energy conversion. Due to the m-shaped flow-impinging surfaces of the eight-arc cylindrical structure, the arc-shaped structure changes the flow direction of the ocean currents and reduces the impact force of ocean currents. The ocean currents flow through a gap between adjacent outer arc-shaped shells into the interior of the device, where it impinges upon rotating impellers arranged in four directions. This process disrupts the boundary layer surrounding the marine riser and thus reduces the intensity of vortex-induced vibration. Under the combined effects of ocean current impacts and the motion of the outer arc-shaped shell driven by the thrust rods, the arc-shaped piezoelectric plates deform and generate electric current. In addition, the relative motion between the arc-shaped piezoelectric plates and the outer arc-shaped shell enables the electret to generate power, thereby converting ocean current energy into electrical energy.

In terms of structural design, the present disclosure adopts the outer arc-shaped shells, using curved surfaces to achieve flow separation of ocean currents and reduce pressure on the flow-impinging surfaces. Internally, a smooth curved flow-guiding structure is arranged in combination with rotating impellers to achieve multi-level attenuation of impact forces, thereby suppressing vortex-induced vibration. In terms of energy conversion, the arc-shaped piezoelectric plates are distributed on the outer arc-shaped shells to generate electricity through the piezoelectric effect, while the electret-based power generation units are installed inside the outer arc-shaped shells to capture and store electrical charges, forming a dual-mode energy conversion system. The device overcomes the limitations of conventional vibration suppression systems that rely on single-phase energy dissipation. While ensuring vibration suppression of marine riser, it simultaneously establishes a sustainable marine power generation system capable of continuous power generation.

Beneficial effects: Compared with the prior art, the present disclosure has the following advantages:
(1) In the present disclosure, each flow-impinging surface of the eight-arc cylinder is m-shaped, and the arc-shaped structure can change a flow direction of ocean currents, which facilitates reducing the impact force of ocean currents and thus lowering the intensity of vortex- induced vibration. The ocean currents flow through a gap between adjacent outer arc-shaped shells into the interior of the device, where it impinges upon rotating impellers arranged in four directions. This process disrupts the boundary layer surrounding the marine riser and thus reduces the intensity of vortex-induced vibration.
(2) The rotation of the rotating impeller in the present disclosure is transmitted through the gears of the power transmission module, which converts the rotary motion into reciprocating motion of the outer arc-shaped shell driven by the thrust rods along the normal direction, thereby providing a turbulence effect.
(3) Under the combined effects of ocean current impacts and the motion of the outer arc-shaped shell driven by the thrust rods, the arc-shaped piezoelectric plates in the present disclosure deform and generate electric current, thereby converting ocean current energy into electrical energy.
(4) In the present disclosure, the upper electrode is fixed inside the outer arc-shaped shell, and an electret is adhered to the surface of the lower electrode. During the relative motion between the arc-shaped piezoelectric plate and the outer arc-shaped shell, the upper electrode moves up and down with vibration. When the air gap between the two components decreases due to external force, the upper electrode approaches the electret film, and the induced charge density on the upper electrode increases correspondingly relative to that on the lower electrode. As a result, the relative potential balance between the two electrodes is disrupted, causing electrons to flow from both electrodes until the next potential equilibrium is reached. In the initial state, no potential difference exists. As the upper electrode moves away from the initial position, the potential difference gradually increases. Although the electret material confines the internal electrons, the alternating potential difference between the two electrodes pumps surface-free charges to circulate in the circuit.
(5) The device of the present disclosure is made of lightweight and corrosion-resistant materials, ensuring low weight and resistant to corrosion.

### BRIEF DESCRIPTION OF THE DRAWINGS

FIG. 1 is a schematic diagram of an overall structure of an eight-arc cylindrical vortex-induced vibration suppression and power generation device according to the present disclosure.

FIG. 2 is a schematic diagram of an overall structure according to the present disclosure.

FIG. 3 is a bottom perspective view of an overall structure according to the present disclosure.

FIG. 4 is a schematic diagram of holes on a bottom of a working chamber according to the present disclosure.

FIG. 5 is a schematic structural diagram of a power transmission module according to the present disclosure.

FIG. 6 is a schematic structural diagram of an outer arc-shaped shell according to the present disclosure.

FIG. 7 is a schematic diagram of a power generation module according to the present disclosure.

FIG. 8 is a detailed schematic diagram of a spur-helical gear set according to the present disclosure.

### DETAILED DESCRIPTIONS OF THE EMBODIMENTS

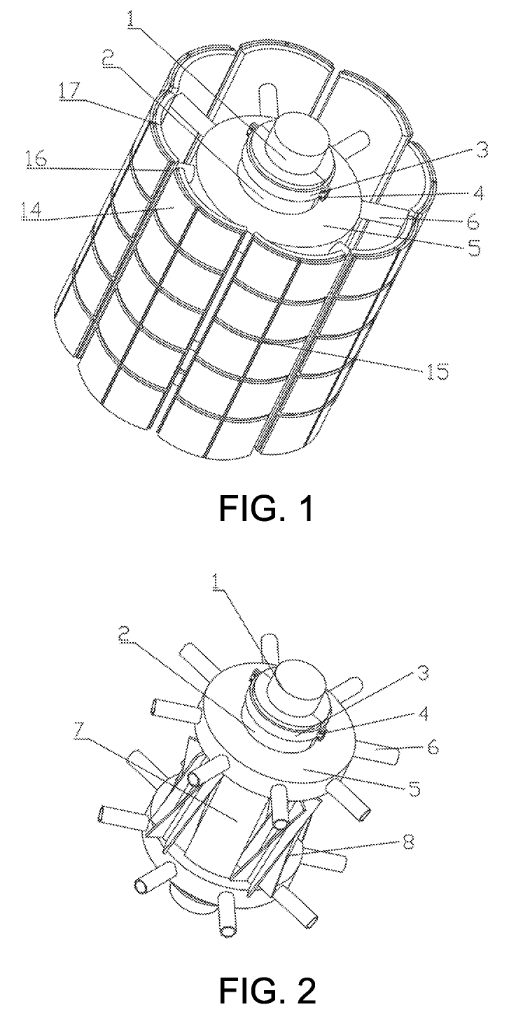

As shown in FIGS. 1-8, the present disclosure provides an eight-arc cylindrical vortex-induced vibration suppression and power generation device for a marine riser, including a marine riser 1, a protection module, a power transmission module, and a power generation module. The protection module includes an inner mounting tube 2 disposed on an outer side of the marine riser, an outer mounting tube disposed on an outer side of the inner mounting tube, and an outer arc-shaped shell 17 connected to the outer mounting tube through thrust rods.

As shown in FIG. 1, the inner mounting tube 2 is sleeved around the marine riser 1 and coaxial with the marine riser 1, ensuring stable connection and structural symmetry between them. The inner mounting tube 2 consists of two outer hollow semi-cylindrical shells. Front and rear ends of the inner mounting tube 2 are secured by tube body reinforcing members 3 connected by mounting bolt assemblies 4 on an outer side. The tube body reinforcing members 3 not only enhance a structural strength of the inner mounting tube 2 but also provide overall stability to the entire device. The mounting bolt assemblies 4 are arranged at positions of the tube body reinforcing members 3, and are configured to fix the inner mounting tube 2 onto the outer side of the marine riser 1, ensuring that the device of the present disclosure can withstand hydrodynamic impact force of ocean currents and maintain long-term operational stability in complex marine environments.

As shown in FIG. 2, the outer mounting tube is fixedly connected to the outer side of the inner mounting tube 2 and is coaxial with the inner mounting tube 2, ensuring structural symmetry and stability of the device. The outer mounting tube includes two working chambers 5, one middle section 7, and eight thrust-rod protective casings 6. The eight thrust-rod protective casings 6 are evenly arranged on a circumference of each working chamber 5. The thrust-rod protective casings 6 provide necessary protection and guidance for the thrust rods, ensuring smooth motion even in harsh marine environments.

A first hole 5-1 and power holes are formed in a bottom of each working chamber 5. The power holes include a second hole 5-2 and a third hole 5-3, as shown in FIG. 4. The holes are used not only for the installation and fixation of rotating impellers but also serve as fixing points for the connection and transmission of spur-helical gear sets inside the working chamber. The bottom of the working chamber separates the working chamber from the middle section, ensuring functional independence and non-interference between the working chamber and the middle section.

The middle section 7 is a cylindrical body having arc-shaped notches in four directions. These arc-shaped notches not only reduce the structural weight but also optimize the flow path of ocean currents, thereby reducing impact force of ocean currents on the device. In addition, these arc-shaped notches provide an installation and operational space for the rotating impellers, such that the device can efficiently generate mechanical power under the action of ocean currents, further driving the power generation module to achieve energy conversion and utilization.

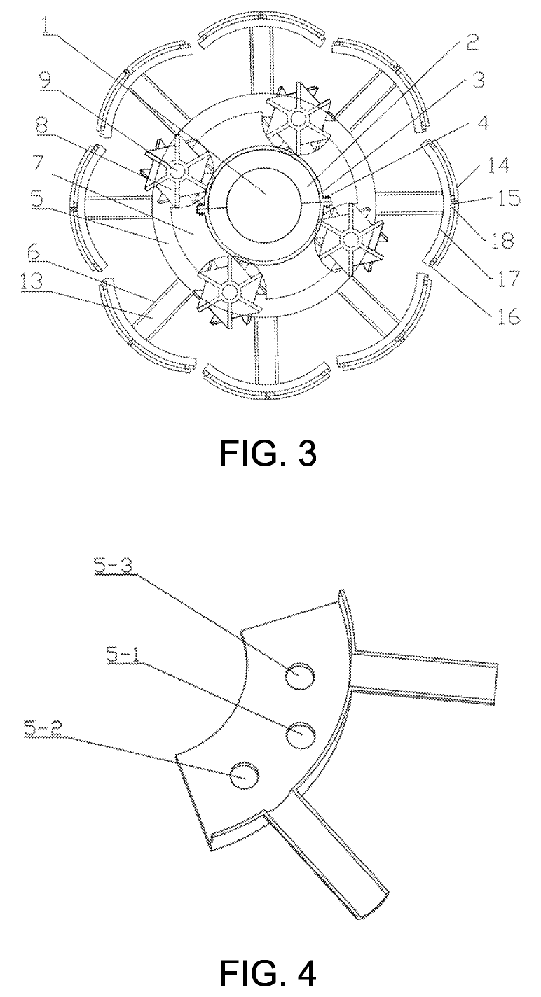

As shown in FIGS. 3 and 6, a total of eight outer arc-shaped shells 17 are provided, the outer arc-shaped shells 17 are evenly distributed around a circumference thereof to form an eight-arc cylindrical structure, such that each flow-impinging surface is m-shaped, effectively reducing the impact of ocean currents. A radius of each outer arc-shaped shell is half of a maximum circle radius, together forming the eight-arc cylindrical structure. Boundary limiting blocks 16 are arranged at both ends of each outer arc-shaped shell 17, and an intermediate limiting block 15 is arranged in a middle thereof. These limiting blocks are configured to ensure that an arc-shaped piezoelectric plate remains within its predetermined track during motion, preventing excessive displacement or deviation, thereby ensuring normal operation of the device.

According to a position of the supporting rod 18 on the arc-shaped piezoelectric plate, a mounting hole is formed in the outer arc-shaped shells 17 to reserve a space for the arrangement of supporting rods 18. Thrust rods 13 are connected to both a front end and a rear end of each outer arc-shaped shell 17. The thrust rods 13 transmit rotational force of the rotating impellers to the outer arc-shaped shells via the power transmission module, thereby causing the outer arc-shaped shell to move, driving the power generation module and realizing efficient conversion of ocean current energy into electrical energy.

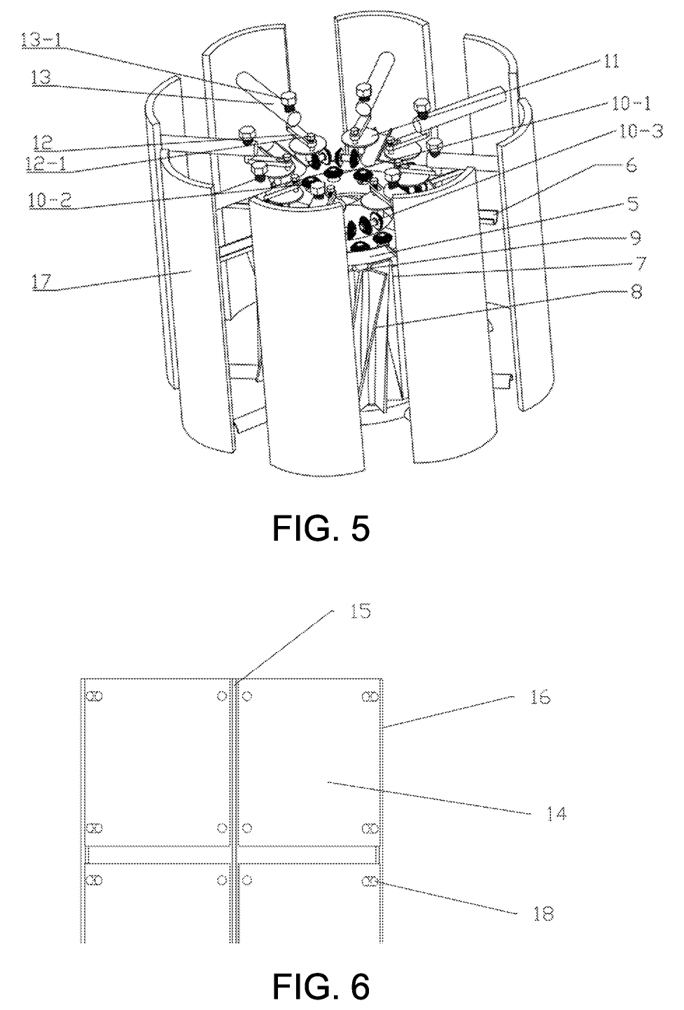

As shown in FIG. 5, the power transmission module is formed by a rotating impeller 8, a fixed rod 9, and a spur-helical gear set. The rotating impeller 8 has obliquely curved blades, and a total of four rotating impellers are evenly arranged at the arc-shaped notches distributed along the circumference of the middle section 7, so as to improve the efficiency of ocean current capture and power conversion.

The spur-helical gear set is formed by a driving spur-helical gear 10-1, bidirectional spur-helical gears 10-3, and driven spur-helical gears 10-2. The rotating impeller 8 is coaxially aligned with the fixed rod 9, ensuring stable rotation of the rotating impeller 8. The fixed rod 9 passes through the bottom of the working chamber 5 and is connected to the driving spur-helical gear 10-1. The fixed rod 9 is coaxial with the first hole 5-1 in the bottom of the working chamber 5 and the driving spur-helical gear 10-1 to ensure efficient and stable power transmission.

The driving spur-helical gear 10-1 simultaneously meshes with one end of each of the two bidirectional spur-helical gears 10-3, the other end of each of the two bidirectional gears 10-3 respectively meshes with the driven spur-helical gear 10-2. The two driven spur-helical gears 10-2 are connected to lower rods of eccentric discs 11 and are fixed in the second hole 5-2 and the third hole 5-3 of the working chamber 5, that is, the driven spur-helical gears 10-2, the lower rods of the eccentric discs 11, and the second hole 5-2 and the third hole 5-3 are all coaxial, as shown in FIG. 4.

Upper rods of the eccentric discs 11 are fixedly connected and reinforced with a straight-slot portion of a straight-slot connecting rod 12 by a straight-slot connecting rod single-pass nut 12-1. The other end of the straight-slot connecting rod 12 is fixedly connected to the thrust rod 13 through a thrust-rod single-pass nut 13-1. The thrust rod 13 is welded to the outer arc-shaped shells 17, forming a complete mechanical power transmission chain that efficiently transmits the hydrodynamic energy of ocean currents to the outer arc-shaped shells, driving the outer arc-shaped shells to move and consequently actuating the power generation module to generate electrical energy.

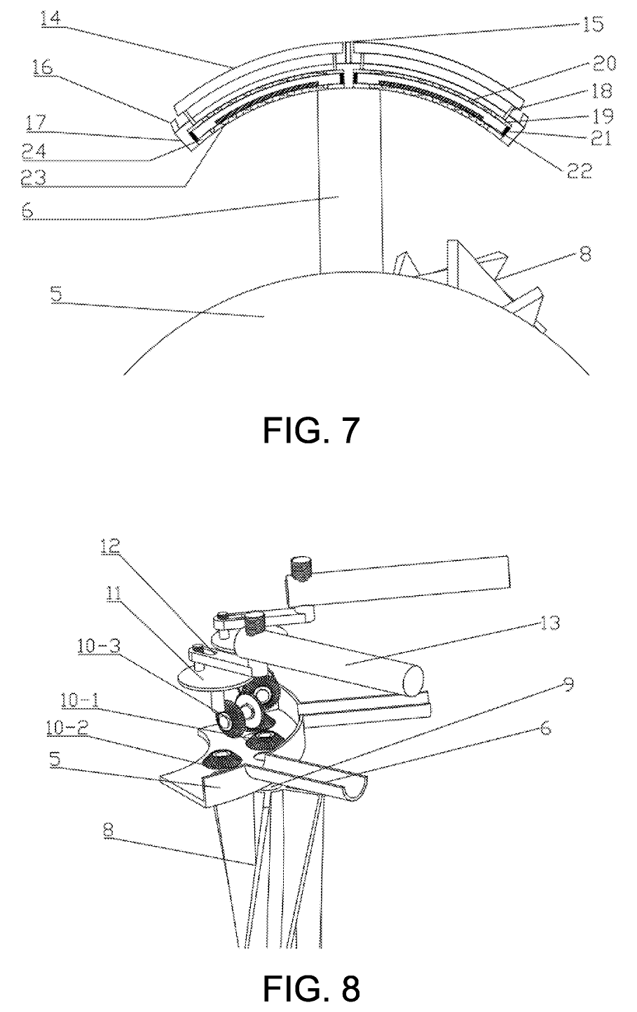

As shown in FIG. 7, the power generation module includes arc-shaped piezoelectric plates 14 and an electret-based power generation unit. The electret-based power generation unit is located inside the outer arc-shaped shell 17, and is formed by an upper base plate 19 and a lower base plate 24 connected by a buffer spring 21, an upper electrode 20 embedded and fixed in the upper base plate 19, a lower electrode 23 embedded and fixed in the lower base plate 24, an electret 22 mounted on the lower electrode 23, and a supporting rod 18 for connecting the arc-shaped piezoelectric plates.

A plurality of arc-shaped piezoelectric plates 14 are evenly distributed on the outer arc-shaped shell 17. The arc-shaped piezoelectric plates 14 are configured to maximize the capture of vibration energy induced by ocean currents and to convert the vibration energy into electrical energy.

Each of four ends of one arc-shaped piezoelectric plate 14 is provided with one supporting rod 18. Each supporting rod 18 passes through a hole formed in the outer arc-shaped shell 17 and is welded to the upper base plate 19 inside the outer arc-shaped shell 17. The upper electrode 20 is embedded and fixed in the upper base plate 19. The upper base plate 19 is connected to the lower base plate 24 via buffer springs 21 located at the four ends. This configuration not only provides necessary mechanical support but also maintains stable contact between the electrodes during vibration. One lower electrode 23 is embedded and fixed in the lower base plate 24, and the lower electrode works cooperatively with the upper electrode to form a complete electrical circuit.

An electret 22 is mounted on the lower electrode 23. The electret 22 retains a charge for an extended period and plays a key role in the power generation process. Through its interaction with the upper electrode, the electret improves energy generation and transmission efficiency of electric energy.

Under the combined effects of ocean current impacts and the motion of the outer arc-shaped shell 17 driven by the thrust rods, the arc-shaped piezoelectric plates 14 deform and generate electric current. In addition, the relative motion between the arc-shaped piezoelectric plates 14 and the outer arc-shaped shell 17 enables the electret 22 to generate power, thereby converting ocean current energy into electrical energy.

The working process of the eight-arc cylindrical vortex-induced vibration suppression and power generation device for a marine riser of the present disclosure is as follows:

Step (1): The device is fixed outside the marine riser, the eight-arc cylindrical outer arc-shaped shells ensures that when the ocean current impacts the device, the flow-impinging surfaces are smooth and m-shaped. This design effectively reduces the impact force of ocean currents, thereby reducing the vibrations of the device caused by the ocean current impact, suppressing vortex-induced vibrations, and ensuring stable operation of the device in complex marine environments.

Step (2): When the ocean currents flow into the device, the rotating impellers inside the device are driven to rotate. This process converts the ocean energy into the mechanical energy of the rotating impellers. Meanwhile, the rotation of the rotating impellers reduce the flow velocity of ocean currents, further reducing the impact force of ocean currents on the device and enhancing the operational stability of the device.

Step (3): When the rotating impellers rotate, the energy is converted through the gear power transmission device inside the working chamber to the centripetal mechanical motion of the outer arc-shaped shells via the thrust rods. The gear transmission system in this process ensures efficient power transmission, and reduces energy loss, thereby improving the overall energy conversion efficiency of the device.

Step (4): The centripetal motion of the outer arc-shaped shells enables the arc-shaped piezoelectric plates on the outer arc-shaped shells to obtain the mechanical energy. The deformation of the piezoelectric plates intensifies under the combined impact and action of ocean currents, resulting in the accumulation of electrical energy. Meanwhile, the mechanical energy of the piezoelectric plates is transferred to the electret-based power generation unit inside the outer arc-shaped shells through the motion of supporting rods, resulting in electret-based power generation. This process combines the piezoelectric effect and the electret-based power generation principle, realizing multi-stage energy conversion and efficient energy utilization. Consequently, the overall power generation efficiency and energy conversion rate of the device are significantly enhanced.

What is claimed is:

1. An eight-arc cylindrical vortex-induced vibration suppression and power generation device for a marine riser, comprising a marine riser, a protection module, a power transmission module, and a power generation module; wherein
the protection module comprises an inner mounting tube disposed on an outer side of the marine riser; an outer mounting tube is disposed on an outer side of the inner mounting tube; the outer mounting tube comprises a middle section having an arc-shaped notch; both ends of the middle section are provided with working chambers, and a plurality of thrust rods are arranged circumferentially around each of the working chambers; one end of each of the thrust rods is provided with an outer arc-shaped shell; and a first hole, and power holes are formed in a bottom of the working chamber;
the power transmission module comprises a rotating impeller, a fixed rod, a driving spur-helical gear, and an eccentric disc; the fixed rod is coaxial with the first hole, the rotating impeller, and the driving spur-helical gear; the rotating impeller is located in a position of the arc-shaped notch; the driving spur-helical gear is engaged with two bidirectional spur-helical gears, and one end of each of the bidirectional spur-helical gears is engaged with a driven spur-helical gear; the driven spur-helical gear passes through the power holes and is connected to a lower rod of the eccentric disc; and an upper rod of the eccentric disc is connected to a straight-slot connecting rod, and the straight-slot connecting rod is connected to the thrust rod; and
the power generation module comprises arc-shaped piezoelectric plates distributed on the outer arc-shaped shell; the outer arc-shaped shell comprises an upper base plate embedded with an upper electrode, and a lower base plate embedded with a lower electrode; a spring is connected between the upper base plate and the lower base plate; and each of the arc-shaped piezoelectric plates is provided with a supporting rod connected to the upper base plate, and an electret is mounted on the lower electrode.

2. The eight-arc cylindrical vortex-induced vibration suppression and power generation device for a marine riser according to claim 1, wherein the middle section is a cylindrical body having arc-shaped notches in four directions.

3. The eight-arc cylindrical vortex-induced vibration suppression and power generation device for a marine riser according to claim 1, wherein the middle section and both ends of the outer arc-shaped shell are provided with limiting blocks to limit movement trajectories of the arc-shaped piezoelectric plates.

4. The eight-arc cylindrical vortex-induced vibration suppression and power generation device for a marine riser according to claim 1, wherein the outer arc-shaped shell is provided with mounting holes for connecting the supporting rod with the upper base plate.

5. The eight-arc cylindrical vortex-induced vibration suppression and power generation device for a marine riser according to claim 1, wherein the thrust rods are sleeved with thrust-rod protective casings.

6. The eight-arc cylindrical vortex-induced vibration suppression and power generation device for a marine riser according to claim 1, wherein the upper rod of the eccentric disc is fixedly connected to a straight slot of the straight-slot connecting rod.

7. The eight-arc cylindrical vortex-induced vibration suppression and power generation device for a marine riser according to claim 1, wherein the outer arc-shaped shells are distributed around its circumference to form an eight-arc cylindrical structure.

8. The eight-arc cylindrical vortex-induced vibration suppression and power generation device for a marine riser according to claim 1, wherein both ends of the inner mounting tube are secured by tube body reinforcing members connected by mounting bolt assemblies on an outer side.

9. The eight-arc cylindrical vortex-induced vibration suppression and power generation device for a marine riser according to claim 1, wherein the power holes formed in the working chamber are a second hole and a third hole, and the two driven spur-helical gears pass through the second hole and the third hole.

10. The eight-arc cylindrical vortex-induced vibration suppression and power generation device for a marine riser according to claim 1, wherein the rotating impeller has obliquely curved blades.
